(19) United States
(12) Patent Application Publication
(10) Pub. No.: US 2025/0001648 A1
(43) Pub. Date: Jan. 2, 2025

(54) COMPOSITE MATERIAL AS ABRASION PROTECTION FOR VEHICLE TIRES, AND PRODUCTION METHOD

(71) Applicant: Continental Reifen Deutschland GmbH, Hannover (DE)

(72) Inventors: Cornelia Schmaunz-Hirsch, Wunstorf (DE); Wolfgang Naumann, Lichtenfels (DE); Michael Jahr, Dresden (DE); Thomas Kramer, Herford (DE); Rainer Kahner, Arnsberg (DE)

(73) Assignee: Continental Reifen Deutschland GmbH, Hannover (DE)

(21) Appl. No.: 18/688,441

(22) PCT Filed: Aug. 24, 2022
(86) PCT No.: PCT/EP2022/073574

§ 371 Date: Mar. 1, 2024

(30) Foreign Application Priority Data
Sep. 3, 2021 (EP) 21194746.0

(51) Int. Cl. B29B 15/12; B60C 1/00; B60C 13/00; B60C 13/04; C08G 18/69; C08J 3/24; C08K 3/013; C08L 9/10; D06M 15/693

(52) U.S. Cl. CPC B29B 15/125; B60C 1/0025; B60C 1/0041; B60C 13/002; B60C 13/04; C08G 18/69; C08J 3/24; C08K 3/013; C08L 9/10; C08L 2555/60; D06M 15/693

(57) ABSTRACT

A process for producing a vulcanizable composite material, including the steps of: a) producing or providing a textile strength member, b) treating the textile strength member with an aqueous dispersion for adhesive activation of the textile strength member and to obtain an adhesion-activated textile strength member and c) introducing the adhesion-activated textile strength member into a crosslinkable rubberization mixture to obtain the vulcanizable composite material, wherein the aqueous dispersion is essentially free of free resorcinol and resorcinol precondensates, especially resorcinol-formaldehyde precondensates, and is free of free formaldehyde and formaldehyde-releasing substances, wherein the crosslinkable rubberization mixture is processible by vulcanization to give a crosslinked rubberization mixture which is at least partly transmissive to visible light at least in sections.

### CROSS-REFERENCE TO RELATED APPLICATIONS

The present application is a National Stage Application under 35 U.S.C. § 371 of International Patent Application No. PCT/EP2022/073574 filed on Aug. 24, 2022, and claims priority from European Patent Application No. 21194746.0 filed on Sep. 3, 2021, the disclosures of which are herein incorporated by reference in their entireties.

### TECHNICAL FIELD

The invention relates to a process for producing a vulcanizable composite material and to a process based thereon for producing a vulcanized composite material or a vehicle tire, and to a corresponding vulcanizable composite material and to a vulcanized composite material producible therefrom or a corresponding vehicle tire.

### BACKGROUND

It is known that vehicle tires, for example bicycle tires, have textile strength members for reinforcement in various components. In many cases, other industrial rubber articles too, such as belts (including transmission belts) and hoses, have strength members. The strength members here are typically surrounded by at least one rubber mixture which is also referred to as rubberization mixture or, in the vulcanized state, as rubberization.

One application for corresponding composite materials which is particularly important for particular bicycle tires, for example mountain bike tires, is that as scour guard, i.e. as protective material layer in the sidewall region of the vehicle tyres or as rim guard in the rim contact region. In the case of corresponding composite materials used as scour guard, the textile strength members that are used partly in the form of weaves usually lie at the surface of the composite materials and are only partly surrounded by the rubberization, such that the textile strength members are exposed at the surface and effectively cover the underlying rubber materials as a protective layer.

In the prior art, the textile strength members, in the production of corresponding composite materials, are usually disposed on the surface of a crosslinkable rubberization mixture. In the later vulcanization, the rubberization mixture is then usually pushed outward against the textile strength members into the vulcanization mold, such that these lie partly in the rubberization in the resultant vulcanized composite material.

It is regularly a problem that the strength members and the surrounding rubberization generally have different mechanical properties, especially different strengths. Particularly in the case of sustained mechanical and dynamic stress, as occurs in traveling operation of the vehicle tire, there is therefore a need for sufficient adhesion between the strength members and the surrounding rubberization in order nevertheless to be able to assure adequate bond strength.

The prior art discloses activation of the strength members prior to rubberization for adequate adhesion (called activation of adhesion or adhesive activation), typically by using what are called RFL (resorcinol-formaldehyde latex) dips that can be applied with a coating bar, for example.

In this form of activation of adhesion, however, it is regularly perceived to be disadvantageous that the RFL dips known from the prior art have a strong intrinsic color, and the usually red-brownish color also limits the options for later coloring with colorants. This disadvantage is particularly serious specifically in the case of use for scour protection, since the textile strength members on the surface are of course intended to be at least partly visible. Moreover, this activation of adhesion regularly masks the color of the textile strength members, even though this could be very informative to the skilled person, especially for identification of the materials used from their color or for recognition of any manufacturer-specific labels, for example indicator filaments. In order to compensate for this disadvantage and to achieve a configuration acceptable to the final customer, what are therefore frequently required in the prior art are more complex production methods in which the textile strength members are coated only on the side intended for the bond to the rubberization.

In the case of the composite materials for scour protection that are known from the prior art, it is sometimes perceived as being disadvantageous that the rubberization that partly surrounds the textile strength members can make it considerably more difficult to verify the proper positioning of the textile strength members and to reliably determine their condition when used in traveling operation. The latter in particular is frequently perceived as being disadvantageous because the textile strength members of the scour guard are intended to be subject to high stresses and are therefore prone to wear.

### SUMMARY

The primary object of the present invention was that of eliminating or at least reducing the above-described disadvantages of the prior art.

It was therefore an object of the present invention to specify a process for producing vulcanizable composite materials that can be used to obtain, by vulcanization, high-performance vulcanized composite materials that are particularly suitable for use as scour guard in vehicle tires. The process to be specified was to be particularly time- and cost-efficient and preferably performable without complex operating steps, for example single-sided activation of adhesion.

It was an object of the present invention for the vulcanized composite materials to enable maximum ease of identification and quality testing, in a reliable and nondestructive manner, of the textile strength members present in the vulcanized composite materials, where it should especially also be possible to clearly distinguish between adjacent textile strength members, such that it should especially also be possible to assess the state of wear of the textile strength members in regions covered by the rubberization.

It was a supplementary object of the present invention for the vulcanized composite materials to have elevated flexibility over the prior art with respect to color configuration. It was especially desirable here for the base color of the textile strength members, in spite of any adhesion-activating coatings, to remain visible especially in order to enable material identification by color and to make manufacturer-specific indicator filaments visible.

It was an additional object of the present invention for the vulcanized composite materials to show sufficiently high composite strength, especially between the textile strength members and the rubberization. It was a further object of the present invention for the positive color properties, by contrast with the case of RFL dips, for example, to be adjustable largely irrespective of the conditions used in the vulcanization.

It will be clear to the person skilled in the art that it was a supplementary object of the present invention additionally to specify a process for producing a vehicle tire, and a corresponding vehicle tire. It was a supplementary object of the present invention for the corresponding vehicle tires ideally to make a contribution to safety of travel.

The inventors of the present invention have now recognized that at least some of the above-specified objects can be achieved when a rubberization which is at least partly transmissive to visible light is used, such that the parts of the textile strength members that are covered by the rubberization are also visible from the outside and can be assessed, for example, with regard to any signs of wear.

However, it has been found to be disadvantageous in the case of this procedure that the disadvantageous color properties of the RFL dips are particularly strongly manifested here, and, in particular, not even an only partial activation of adhesion in this basically advantageous configuration can prevent the disadvantageous color of the RFL dip from being visible.

The inventors of the present invention have now recognized that the objects defined above can be achieved when a specific form of activation of adhesion as defined in the claims is used.

The above-stated objects are thus achieved by means of the subject matter of the invention as defined in the claims. Preferred configurations according to the invention will be apparent from the subsidiary claims and from the details that follow.

### DETAILED DESCRIPTION

Embodiments that are referred to below as being preferred are, in particularly preferred embodiments, combined with features of other embodiments that are referred to as being preferred. Combinations of two or more of the embodiments that are described below as being particularly preferred are therefore very particularly preferred. Likewise preferred are embodiments in which a feature of one embodiment that is referred to as being preferred to a certain degree is combined with one or more further features of other embodiments that are referred to as being preferred to a certain degree. Features of preferred vulcanizable composite materials, of vulcanized composite materials, and of vehicle tires will be apparent from the features of preferred processes.

The invention relates to a process for producing a vulcanizable composite material, comprising the steps of:
a) producing or providing a textile strength member,
b) treating the textile strength member with an aqueous dispersion for adhesive activation of the textile strength member and to obtain an adhesion-activated textile strength member and
c) arranging the adhesion-activated textile strength member on the surface of a base material comprising a crosslinkable rubberization mixture to obtain the vulcanizable composite material,
wherein the aqueous dispersion is essentially free of free resorcinol and resorcinol precondensates, especially resorcinol-formaldehyde precondensates, and is free of free formaldehyde and formaldehyde-releasing substances,
wherein the crosslinkable rubberization mixture is processible by vulcanization to give a crosslinked rubberization mixture which is at least partly transmissive to visible light at least in sections.

The process of the invention affords vulcanizable composite materials from which high-performance vulcanized composite materials having excellent bond strength can be obtained by vulcanization, which have excellent suitability as scour guard for vehicle tires. In the vulcanized composite materials, it is advantageously possible by virtue of the specifically chosen activation of adhesion to inspect parts of the textile strength members covered by the rubberization from the outside as well, such that reliable and nondestructive quality testing is possible, which can especially also be undertaken by laypeople.

In a synergistic manner, the chosen activation of adhesion surprisingly does not cause unwanted coloring, since this may advantageously be made colorless or transparent. This makes it possible to see the original color of the textile strength members, which means, for example, that information about the materials used in the textile strength members and/or manufacturer information, coded by indicator filaments for example, remains visible. This additionally makes it possible to significantly increase flexibility with regard to color configuration, since it is advantageously possible not just to color the rubberization but likewise to color the textile strength members, such as a color of the adhesion-activating coating. It can be considered here to be an advantage of the invention that the positive color properties can be obtained largely irrespective of the temperatures used in the vulcanization.

The above-described benefits also mean that the production of a corresponding scour guard is more efficiently possible, since it is unnecessary in this process regime to conduct the activation of adhesion merely selectively on one side of the textile strength members.

Finally, it can be regarded as an advantage of the process of the invention that, in the vulcanized composite materials, depending on the mode of activation of adhesion, a slight gloss arises in the textile strength members, which, depending on the color chosen, can go in the direction of a metallic gloss. By virtue of the use of a corresponding composite material in place of a conventional scour guard with a largely absorbent black rubber material, this gloss increases the visibility of the tire specifically under difficult viewing conditions, since, for example, a higher proportion of incident headlamp light can be reflected.

The definition of the crosslinkable rubberization mixture via the properties of the rubberization producible therefrom by vulcanization, i.e. of the crosslinked rubberization mixture, is in accordance with the customary procedure in the art and the understanding of the person skilled in the art, since a corresponding definition in the case of corresponding polymeric materials having a structure that cannot be described exactly is regularly the only practicable way of defining the corresponding material. A vulcanized composite material producible from the vulcanizable composite material accordingly comprises a crosslinked rubberization mixture which is at least partly transmissive to visible light at least in sections.

In the context of the present invention, the expression “at least partly transmissive to visible light”, in accordance with the understanding of the person skilled in the art, means that the crosslinked rubberization mixture shows sufficiently little interaction with electromagnetic radiation of any wavelength in the visible region, or a portion of the wavelengths in the visible region, that the textile strength members in the vulcanizable composite material and in the vulcanized composite material are visible from the outside. This means that it is unnecessary for the crosslinked rubberization mixture to show no absorption at all in the visible wavelength region, since partial absorption, for example at particular wavelengths, can also be tolerated, especially in the case of transparently colored rubberizations.

According to the above definition, the crosslinked rubberization mixture is at least partly transmissive to visible light at least in sections. This means that the vulcanizable composite material or the vulcanized composite material may also include sections in which the rubberization has not been made transmissive, for example in the form of alternating regions beneath the textile strength members.

The expression “essentially free of”, in accordance with the understanding of the person skilled in the art, in the context of the present invention, should be understood to mean that the corresponding substances may be present only in amounts that do not significantly influence the essential properties of the composition claimed. For example, the amount of these substances must not go beyond trace amounts that result from a contamination. Typically, in the aqueous dispersion for use in accordance with the invention, there should be not more than 0.1% by weight (dry weight of the aqueous dispersion), based on the total weight of aqueous dispersion, of each of the components specified, for instance resorcinol, resorcinol precondensates, formaldehyde and formaldehyde-releasing substances, i.e. 0.1% by weight is the maximum amount for each of the above components. The content of all these components in the aqueous dispersion is preferably 0% by weight.

The unit “phr” (parts per hundred parts of rubber by weight) used in the context of the present invention is the standard unit of quantity for mixture recipes in the rubber industry. The dosage of the parts by weight of the individual substances is always based here on 100 parts by weight of the total mass of all rubbers present in the mixture, which accordingly adds up to 100.

Preference is fundamentally given to a process of the invention wherein the adhesion-activated textile strength member is disposed on the surface of the base material such that the adhesion-activated textile strength member is partly surrounded by the crosslinkable rubberization mixture.

Specifically for applications with high expected stress, preference is given to a process of the invention wherein the textile strength member disposed at the surface of the base material and/or the surface of the base material is coated with a coating material, wherein the coating material comprises one or more fillers selected from the group consisting of hard ceramic substances, glasses and vitreous materials, preferably hard ceramic substances, wherein the proportion by mass of fillers in the coating material is preferably 5% to 10%, based on the mass of the coating material, wherein the coating material preferably comprises binders based on at least one vulcanizable polymer, more preferably polyisoprene, polybutadiene, styrene-butadiene rubber or natural rubber, most preferably a binder based on polyurethane.

The process of the invention is advantageously suitable for all textile strength members known to the person skilled in the art. However, the inventors of the present invention were able to identify features of the textile strength member that are particularly suitable for the process of the invention.

To wit, a preferred process of the invention is one wherein the textile strength member is at least partly colored and/or comprises at least one characteristic filament, preferably comprises at least one characteristic filament. In this configuration, the advantages of the process of the invention are manifested particularly clearly.

Preference is additionally given to a process of the invention wherein the textile strength member comprises a material selected from the group consisting of polyesters, polyamides, polyurethanes, glass, carbon, celluloses, polycarbonates, polyketones and combinations of those materials, preferably selected from the group consisting of polyesters, regenerated cellulose, especially rayon, aramids, nylon and combinations of those materials, more preferably selected from the group consisting of nylon, where the textile strength member most preferably consists of those materials. Suitable polyesters include, for example, polyethylene terephthalate (PET), polyethylene naphthalate (PEN), polybutylene terephthalate (PBT), polyethylene furanoate (PEF) and polyester acrylates, which are supplied, for example, by Celanese AG under the Vectran trade name. Examples of polyamides are nylon-4,6 (PA 4.6), nylon-4,10 (PA 4.10), nylon-6 (PA 6), nylon-6,6 (PA 6.6 polyhexamethyleneadipamide), nylon-6,12 (PA 6.12), nylon-10,10 (PA 10.10) and nylon-12,12 (PA 12.12). Suitable polyamides are, for example, aromatic polyamides such as aramids, especially m-aramid, p-aramid, and mixtures of m-aramid and p-aramid. Suitable celluloses are, for example, regenerated celluloses (especially viscose or rayon) and cellulose esters.

Preference is also given to a process of the invention wherein the textile strength member comprises one or more reinforcement cords, preferably in the form of a weave, in each case comprising at least one yarn. For example, the textile reinforcement material may take the form of single- or multifilament textile cords or take the form of two-dimensional filament fabrics such as fillets based on single- or multifilament yarns.

Against this background, preference is given to a process of the invention wherein the textile strength member comprises one or more reinforcement cords, preferably in the form of a weave, in each case comprising at least two different yarns, where the yarns each preferably consist of a material selected from the group consisting of polyesters, polyamides, polyurethanes, glass, carbon, celluloses, polycarbonates and polyketones.

Preference is fundamentally given to a process of the invention wherein at least one of the yarns, preferably all the yarns, in the reinforcement cords have a linear density in the range from 90 to 5000 dtex, preferably in the range from 100 to 2500 dtex or in the range from 2500 to 4500 dtex, more preferably in the range from 200 to 1500 dtex or in the range from 3000 to 4000 dtex.

Preference is fundamentally also given to a process of the invention wherein at least one of the yarns, preferably all the yarns, in the reinforcement cords have a twist level of 100 to 600 T/m, preferably 150 to 550 T/m, more preferably 200 to 500 T/m.

Preference is fundamentally given additionally to a process of the invention wherein the polyamide yarn has a twist factor in the range from 100 to 400, preferably in the range from 150 to 350. The twist factor α is a parameter known to the person skilled in the art and is calculated from the twist level in T/m (turns per meter) and the linear density in tex:

$$α = T / m \sqrt{\frac{tex}{1000}}$$

Preference is fundamentally likewise given to a process of the invention wherein at least one of the reinforcement cords, preferably all the reinforcement cords, have two or more yarns, where the yarns in the reinforcement cord have preferably been end-twisted together at 100 to 600 T/m, more preferably at 150 to 550 T/m, most preferably at 200 to 500 T/m.

Preference is fundamentally also given to a process of the invention wherein at least one of the reinforcement cords, preferably all the reinforcement cords, have an overall linear density in the range from 180 to 10 000 dtex, preferably in the range from 200 to 7500 dtex, more preferably in the range from 400 to 5000 dtex.

It will be apparent to the person skilled in the art that it is also possible in the process of the invention to process multiple strength members and incorporate them into a corresponding vulcanizable composite material. For the predominant number of cases, a corresponding process design is actually preferred. Preference is accordingly given to a process of the invention wherein the process is conducted for two or more textile strength members.

The production of vulcanizable rubberization mixtures that result in transmissive, especially transparent, vulcanized rubberization mixtures after vulcanization is known in principle to the person skilled in the art from the prior art, for example from DE 8234954 U1, U.S. Pat. No. 6,624,220 B1 and US 2004/0044118 A1, and so the person skilled in the art can be guided by the prior art in the production.

As described above, it is possible to make merely parts of the rubberization transmissive, for example in that the crosslinkable rubberization mixture consists of two or more rubberization mixture components. Even though it may be preferred specifically in relation to the optical effect, easier manufacture means that preference is given in most cases to rubberizations that are essentially entirely transmissive. Preference is thus given to a process of the invention wherein the crosslinkable rubberization mixture comprises two or more separate rubberization mixture components, wherein at least one rubberization mixture component is processible by vulcanization to give a crosslinked rubberization mixture component which is at least partly transmissive to visible light. Preference is alternatively given to a process of the invention wherein the crosslinkable rubberization mixture is processible by vulcanization to give a crosslinked rubberization mixture which is at least partly transmissive to visible light essentially in its entirety.

With regard to the relevant wavelength ranges in which the rubberization should be transmissive, it is possible to define a suitable range, with particular preference for essentially no diffuse scattering by the rubberization, such that it is transparent. Preference is thus given to a process of the invention wherein the crosslinkable rubberization mixture is processible by vulcanization to give a crosslinked rubberization mixture which is at least partly transmissive to visible light having a wavelength in the range from 380 to 780 nm at least in sections, preferably essentially in its entirety. Preference is likewise given to a process of the invention wherein the crosslinkable rubberization mixture is processible by vulcanization to give a crosslinked rubberization mixture which is at least partly transparent to visible light at least in sections, preferably essentially in its entirety.

The inventors of the present invention have been able to identify compositions particularly suitable for the crosslinkable rubberization mixture.

To wit, preference is given to a process of the invention wherein the crosslinkable rubberization mixture comprises at least one diene rubber, where the diene rubber is preferably selected from the group consisting of halogenated copolymers of a C4 to C7 isoolefin and an alkylstyrene, natural polyisoprene (NR), synthetic polyisoprene (IR), butadiene rubber (BR), styrene-butadiene rubber (SBR), styrene-isoprene rubber, butyl rubber, nitrile rubber (NBR), chloroprene rubber, isoprene-butadiene rubber and ethylene-propylene rubber, where the diene rubber is more preferably selected from the group consisting of brominated copolymers of isobutylene and para-methylstyrene, natural polyisoprene, synthetic polyisoprene and cis-1,4-butadiene rubber. For example, the polyisoprene (IR, NR) may either be cis-1,4-polyisoprene or 3,4-polyisoprene. Preference is given, however, to using cis-1,4-polyisoprenes having a cis-1,4 content of >90% by weight. For example, it is possible to obtain such a polyisoprene by stereospecific polymerization in solution with Ziegler-Natta catalysts or using finely divided lithium alkyls. Moreover, natural rubber (NR) is such a cis-1,4-polyisoprene; the cis-1,4 content in natural rubber is greater than 99% by weight.

The polybutadiene (BR) may, for example, be cis-1,4-polybutadiene or vinylpolybutadiene (vinyl content about 10% to 90% by weight). Preference is given to using cis-1,4-polybutadiene with a cis-1,4 content greater than 90% by weight, which can be prepared, for example, by solution polymerization in the presence of catalysts of the rare earth type.

The styrene-butadiene copolymers (SBR) may, for example, be solution-polymerized styrene-butadiene copolymers (S-SBR) having a styrene content, based on the polymer, of about 10% to 45% by weight and a vinyl content (i.e. content of 1,2-bonded butadiene, based on the overall polymer) of 10% to 70% by weight, which can be prepared, for example, using lithium alkyls in organic solvents. The S-SBR may also be coupled and endgroup-modified. Alternatively, it is possible to use emulsion-polymerized styrene-butadiene copolymers (E-SBR) and mixtures of E-SBR and S-SBR. The styrene content of the E-SBR is about 15% to 50% by weight, and it is possible to use, for example, the products known from the prior art that have been obtained by copolymerization of styrene and 1,3-butadiene in aqueous emulsion.

For example, the halogenated copolymer of a C4 to C7 isoolefin and an alkylstyrene may consist of an isobutylene and a methylstyrene, where the styrene unit may be ortho-, meta- or para-alkylated. The copolymer may have been halogenated with any halogen. Preference is given to using a brominated copolymer of isobutylene and para-methylstyrene. The diene rubbers used in the mixture, especially styrene-butadiene copolymers, may also be used in partly or fully functionalized form. The functionalization can be effected with groups which can interact with the fillers used, especially with fillers bearing OH groups. Functionalizations may, for example, be those with hydroxyl groups and/or epoxy groups and/or siloxane groups and/or amino groups and/or phthalocyanine groups and/or carboxyl groups and/or silane sulfide groups.

Preference is given in this respect to a process of the invention wherein the crosslinkable rubberization mixture comprises 25 to 100 phr, preferably 50 to 100 phr, more preferably 70 to 100 phr, of the at least one diene rubber.

Preference is additionally given to a process of the invention wherein the crosslinkable rubberization mixture comprises 15 to 50 phr of a brominated copolymer of isobutylene and para-methylstyrene and/or 25 to 85 phr of natural and/or synthetic polyisoprene and/or 15 to 50 phr of cis-1,4-butadiene rubber.

Preference is also given to a process of the invention wherein the crosslinkable rubberization mixture comprises 10 to 90 phr, preferably 15 to 40 phr, of a filler, preferably amorphous silicon dioxide, especially precipitated silica, where the crosslinkable rubberization mixture most preferably comprises a polar filler, especially amorphous silicon dioxide, and one or more silane compounds for binding of the polar fillers. The filler may be any suitable material known in the prior art for use as a filler, or a mixture of these materials. The rubberization mixture preferably comprises silica as filler, which is referred to in the specialist field as amorphous silicon dioxide. This may comprise customary silicas for tire rubber mixtures. It is particularly preferable when a finely divided, precipitated silica is used, having a CTAB surface area (to ASTM D 3765) of 30 to 350 m²/g, preferably of 120 to 250 m²/g. Silicas used may, for example, be either conventional silicas, such as those of the VN3 type (trade name) from Evonik, or highly dispersible silicas known as HD silicas (e.g. Ultrasil 7000 from Evonik).

For some applications, preference is given to a process of the invention wherein the crosslinkable rubberization mixture additionally comprises 0.1 to 10 phr of further fillers, where the further fillers are selected from the group consisting of aluminosilicates, chalk, starch, magnesium oxide, titanium dioxide, rubber gels and combinations of these fillers. Preference is alternatively given to a process of the invention wherein the crosslinkable rubberization mixture comprises less than 0.005 phr, preferably less than 0.001 phr, of the further fillers.

In order to obtain filler-containing transmissive rubberizations, it is regularly productive to minimize the content of black pigments and other colorants. Preference is therefore given to a process of the invention wherein the crosslinkable rubberization mixture comprises less than 1 phr, preferably less than 0.1 phr, more preferably less than 0.01 phr, of black colorants, especially black pigments, especially carbon black, graphene or carbon nanotubes, as filler.

The vulcanization of the crosslinkable rubberization mixture is regularly performed in the presence of sulfur and/or sulfur donors, and some sulfur donors can simultaneously act as vulcanization accelerators. Sulfur or sulfur donors are added to the rubberization mixture in the last mixing step in the amounts that are commonly used by the person skilled in the art (0.4 to 8 phr, sulfur preferably in amounts of 0.4 to 4 phr). The vulcanization can also be effected in the presence of very small amounts of sulfur in combination with sulfur donor substances. In addition, the rubberization mixture may comprise vulcanization-influencing substances such as vulcanization accelerators, vulcanization retardants and vulcanization activators in customary amounts, in order to control the time required and/or the temperature required in the vulcanization and to improve the vulcanizate properties. The vulcanization accelerators may, for example, be selected from the following groups of accelerators: thiazole accelerators, for example 2-mercaptobenzothiazole, sulfenamide accelerators, for example benzothiazyl-2-cyclohexylsulfenamide (CBS), guanidine accelerators, for example N,N′-diphenylguanidine (DPG), dithiocarbamate accelerators, for example zinc dibenzyldithiocarbamate, disulfides, thiophosphates. The accelerators can also be used in combination with one another, which can give rise to synergistic effects. Against this background, preference is given to a process of the invention wherein the crosslinkable rubberization mixture comprises 0.4 to 8.0 phr, preferably 0.4 to 4 phr, more preferably 0.5 to 2.5 phr, of sulfur, where the crosslinkable rubberization mixture preferably comprises one or more further vulcanization additives selected from the group consisting of vulcanization accelerators, vulcanization retardants and vulcanization activators.

Preference is additionally given to a process of the invention wherein the crosslinkable rubberization mixture comprises one or more additives selected from the group consisting of coupling agents, especially silane coupling agents, plasticizers, aging stabilizers, activators, waxes, tackifying resins, mastication aids and processing aids. Useful plasticizers include all plasticizers known to those skilled in the art, for example aromatic, naphthenic or paraffinic mineral oil plasticizers, for example MES (mild extraction solvate) or TDAE (treated distillate aromatic extract), or rubber-to-liquid oils (RTL) or gas-to-liquid oils (GTL) or biomass-to-liquid oils (BTL; as disclosed in DE 10 2008 037 714 A1) or oils based on renewable raw materials, for example rapeseed oil, terpene oils (e.g. orange oils) or factices or plasticizer resins or liquid polymers (such as liquid BR), the average molecular weight of which (determined by GPC=gel permeation chromatography, using a method based on BS ISO 11344:2004) is in the range from 500 to 20 000 g/mol. If liquid polymers are used as plasticizers in the rubberization mixture, these are not counted as rubber in the calculation of the composition of the polymer matrix (phr calculation). When mineral oil is used, particular preference is given to white oils. Aging stabilizers are, for example, substances such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD) and 2,2,4-trimethyl-1,2-dihydroquinoline (TMQ). Activators used are, for example, zinc oxide, zinc carbonate and fatty acids (e.g. stearic acid). One example of a mastication aid is, for example, 2,2′-dibenzamidodiphenyl disulfide (DBD). The processing aids include, for instance, fatty acid salts, for example zinc soaps, and fatty acid esters and derivatives thereof, for example PEG carboxylates.

Particularly pleasing visual effects can be created when the crosslinkable rubberization mixture is colored and transmissive, especially colored and transparent, i.e. shows nonuniform absorption characteristics in the visible spectrum, which can be achieved by dyes. Preference is therefore given to a process of the invention wherein the crosslinkable rubberization mixture comprises one or more dyes.

Suitable aqueous dispersions for activation of adhesion are especially those systems that are disclosed, for example, in WO 2019/015792 A1 and in EP 3702521 A1, EP 3702522 A1 and EP 3702523 A1.

Preference is fundamentally given in this respect to a process of the invention wherein the aqueous dispersion comprises:
(w1) at least one rubber latex, provided that said rubber latex is not a polyisoprene rubber latex (including synthetic and natural polyisoprene rubber latex), and
(w2) at least one protected isocyanate, and
(w3) at least one filler and/or at least one polymer having carboxylic acid-functional groups and/or at least one polyisoprene rubber (including synthetic and natural polyisoprene rubber latex) and/or at least one wax.

An example of useful rubber latex is VP latex. VP latex is known to those skilled in the art. “VP” stands for “vinylpyridine”, and known VP latices may also include additional monomers. A preferred example of a VP latex is a vinylpyridine latex which typically comprises 15% vinylpyridine, 15% styrene and 70% butadiene monomers. As well as the VP latex, the aqueous dispersion may comprise one or more additional latices, for instance a styrene-butadiene latex (SBR) and natural latex (NR).

For isoprene rubber, preference is given to the use of natural latex with a high ammonia content that comes from the “Hevea Brasiliensis” tree.

Suitable polyisocyanate compounds as a constituent of bath/dips for textile strength members are known in principle to those skilled in the art. The polyisocyanate compound may be blocked with another compound or be in the form of a dimer or higher homolog, i.e. in “self-blocked” form. Blocked polyisocyanates are, for example and with preference, obtained by blocking free isocyanates with at least one substance selected from the group consisting of phenol, thiophenol, chlorophenol, cresol, resorcinol, p-sec-butylphenol, p-tert-butylphenol, p-sec-amylphenol, p-octylphenol, p-nonylphenol, tert-butyl alcohol, diphenylamine, dimethylaniline, phthalimide, O-valerolactam, ¿-caprolactam, dialkyl malonate, acetylacetone, alkyl acetoacetate, acetoxime, methyl ethyl ketoxime, 3,5-dimethylpyrazole, cyclohexanone oxime, 3-hydroxypyridine and acidic sodium sulfite. It is preferable in the context of the present invention for the polyisocyanate compound to comprise units selected from the group consisting of tetramethylene diisocyanate, hexamethylene diisocyanate, diphenylmethane 4,4′-diisocyanate, octamethylene diisocyanate, decamethylene diisocyanate, dodecamethylene diisocyanate, aromatic diisocyanates comprising toluene 2,4- or 2,6-diisocyanate, tetramethylxylylene diisocyanate, p-xylene diisocyanate, 2,4′- or 4,4′-diisocyanatodiphenylmethane, phenyl 1,3- or 1,4-diisocyanate.

The polycarboxylic acid is based, for example, to an extent of 10 to 100 mol %, preferably to an extent of 30 to 100 mol %, more preferably to an extent of 50 to 100 mol %, even more preferably to an extent of 70 to 100 mol %, especially preferably to an extent of 90 to 100 mol %, on monomers containing carboxylic acid groups. In a particularly advantageous embodiment of the invention, the polycarboxylic acid is based to an extent of 100 mol % on monomers containing carboxylic acid groups, without ruling out further functional groups. Preferably, the polycarboxylic acid has a weight-average molecular weight Mw by GPC of 1000 to 500 000 g/mol, preferably 3000 to 100 000 g/mol. Preferably, the polycarboxylic acid is based on acrylic acid, methacrylic acid, itaconic acid, crotonic acid, cinnamic acid and/or maleic acid monomers. In a preferred embodiment, the polycarboxylic acid (based on acrylic acid monomers) is an acrylic resin.

Suitable epoxy compounds as a constituent of corresponding aqueous dispersions are known in principle to the person skilled in the art. It is preferable in the context of the present invention for the epoxy compound to be selected from the group consisting of glycidyl-based glycerol, sorbitol-based epoxy compounds, phenol-based novolak epoxy compounds and cresol-based novolak epoxy compounds. A particularly suitable example of an epoxy compound is a glycerol-based polyglycidyl ether, for example Denacol™ EX-313, which is described inter alia in DE 69722388 T2.

Possible waxes as a constituent of corresponding aqueous dispersions are known in principle to the person skilled in the art. Preferred examples are paraffinic waxes, microcrystalline waxes, synthetic waxes and waxes from natural sources, for example beeswax, also including combinations of two or more waxes.

Particularly suitable fillers for the aqueous dispersion are water-dispersible inorganic fillers. Particular preference is given to amorphous silicon dioxide (especially precipitated silica) and silicates having a BET surface area (to ISO 9277:2010) of 30 to 450 m²/g, preferably of 120 to 410 m²/g.

The aqueous dispersion preferably has a pH of 5 to 11, preferably of 7 to 11, which can appropriately be established with a base. The base is preferably a volatile base which evaporates, or the constituents of which evaporate, during the process. In a particularly advantageous embodiment of the invention, the base is ammonium hydroxide, i.e. an aqueous solution of ammonia.

In the light of the above details, preference is given to a process of the invention wherein the aqueous dispersion comprises:
(x1) at least one rubber latex, preferably in a proportion by mass based on the dry weight of the aqueous dispersion of 4% to 60%, and
(x2) at least one protected isocyanate, preferably in a proportion by mass based on the dry weight of the aqueous dispersion of 0.1% to 10%.

Preference is additionally given to a process of the invention wherein the aqueous dispersion comprises:
(y1) at least one compound containing an epoxy group, preferably in a proportion by mass based on the dry weight of the aqueous dispersion of up to 6%, and/or
(y2) at least one polymer having carboxylic acid-functional groups, preferably in a proportion by mass based on the dry weight of the aqueous dispersion of up to 15%.

Particular preference is given to a process of the invention wherein the aqueous dispersion comprises one of the following components:
(z1) at least one filler, preferably in a proportion by mass based on the dry weight of the aqueous dispersion of 0.02% to 20%, preferably with the proviso that the aqueous dispersion does not include any polymer having carboxylic acid-functional groups, or
(z2) at least one polyisoprene rubber latex, preferably in a proportion by mass based on the dry weight of the aqueous dispersion of 1% to 20%, preferably with the proviso that the aqueous dispersion includes at least one rubber latex which is not a polyisoprene rubber latex, or
(z3) at least one wax, preferably in a proportion by mass based on the dry weight of the aqueous dispersion of 0.3% to 30%.

Among the possible aqueous dispersions for activation of adhesion, in the opinion of the inventors, three specific embodiments are particularly suitable.

To wit, preference is given to a process of the invention wherein the aqueous dispersion comprises:
(h1) at least one rubber latex, in a proportion by mass based on the dry weight of the aqueous dispersion of 4% to 50%, preferably of 4.5% to 25%,
(h2) at least one protected isocyanate, in a proportion by mass based on the dry weight of the aqueous dispersion of 0.1% to 4.5%, preferably of 0.2% to 4%,
(h3) at least one filler, in a proportion by mass based on the dry weight of the aqueous dispersion of 0.02% to 20%, preferably of 0.3% to 15%.

Preference is alternatively given to a process of the invention wherein the aqueous dispersion comprises:
(i1) at least one rubber latex, in a proportion by mass based on the dry weight of the aqueous dispersion of 4% to 50%, preferably of 4.5% to 25%,
(i2) at least one protected isocyanate, in a proportion by mass based on the dry weight of the aqueous dispersion of 0.1% to 10%, preferably 0.2% to 4.5%,
(i3) at least one wax, in a proportion by mass based on the dry weight of the aqueous dispersion of 0.3% to 30%, preferably of 0.5% to 15%.

Preference is alternatively in turn given to a process of the invention wherein the aqueous dispersion comprises:
(j1) at least one rubber latex, in a proportion by mass based on the dry weight of the aqueous dispersion of 4% to 40%, preferably of 4.5% to 20%, where the rubber latex is not a polyisoprene rubber latex,
(j2) at least one protected isocyanate, in a proportion by mass based on the dry weight of the aqueous dispersion of 0.1% to 10%, preferably 0.2% to 4.5%,
(j3) at least one polyisoprene rubber latex, preferably in a proportion by mass based on the dry weight of the aqueous dispersion of 1% to 20%, preferably 2% to 15%.

With exploitation of the advantageous lack of intrinsic color of the aqueous dispersion, the resultant activation of adhesion can be particularly easily colored. Preference is therefore given to a process of the invention wherein the aqueous dispersion comprises one or more pigments and/or dyes.

Even if a different application method is possible, the aqueous dispersion is preferably applied as a dip, which is possible without visual detriments because of the advantageous low intrinsic color in spite of the use as scour guard and in spite of the transmissive rubberization. Preference is therefore given to a process of the invention wherein the treatment in step b) comprises dipping the textile strength member into the aqueous dispersion, wherein the treatment preferably additionally comprises hot stretching of the dipped textile strength members.

The vulcanizable composite materials produced by the process of the invention may be incorporated into vehicle tire blanks, for example into blanks for bicycle tires. Preference is consequently also given to a process of the invention additionally comprising the step of:

d) producing an unvulcanized vehicle tyre blank, especially an unvulcanized bicycle tire blank, comprising the vulcanizable composite material.

The unvulcanized vehicle tire blanks manufactured above, or else in less preferred cases merely the unvulcanized composite materials, can be used to produce, by vulcanization, the advantageous vulcanized composite materials or the vehicle tires comprising said vulcanized composite materials. The invention therefore also relates to a process for producing a vehicle tire, especially a bicycle tire, or a vulcanized composite material, comprising the steps of the process of the invention for producing a vulcanizable composite material, and additionally at least one of the following steps:
e) vulcanizing the vulcanizable composite material to obtain a vulcanized composite material, and/or
f) vulcanizing the unvulcanized vehicle tire blank to obtain a vehicle tire,
wherein the vulcanizing is effected such that the adhesion-activated textile strength member, at least in sections, lies at the surface of the vulcanized composite material and/or of the vehicle tire, wherein the vulcanizing is preferably effected such that the adhesion-activated textile strength member is partly surrounded by the crosslinked rubberization mixture.

Preference is given in this respect to a process of the invention wherein the vehicle tire is a bicycle tire, wherein the width of the tire casing transverse to rolling direction is preferably in the range from 20 to 70 mm, preferably in the range from 25 to 65 mm, and/or wherein the internal diameter of the tire casing is preferably in the range from 340 to 640 mm, preferably in the range from 550 to 630 mm.

Very particular preference is given to a process of the invention wherein the vehicle tire comprises the vulcanized composite material as part of the sidewall, preferably as scour guard.

In the light of the above details, it will be apparent to the person skilled in the art that the invention also relates to the vulcanizable composite material produced by the process of the invention, to the vulcanized composite material producible therefrom and to the corresponding vehicle tires, respectively resulting in the benefits discussed above.

The invention thus also relates to a vulcanizable composite material for the production of vehicle tires, preferably produced or producible by the process of the invention for production of a vulcanizable composite material, comprising:
i) at least one textile strength member that has been adhesion-activated at least in sections, preferably essentially entirely, with an aqueous dispersion, and
ii) a base material comprising a crosslinkable rubberization mixture,
wherein the textile strength member is disposed at the surface of the base material,
wherein the textile strength member is preferably partly surrounded by the crosslinkable rubberization mixture,
wherein the aqueous dispersion is essentially free of free resorcinol and resorcinol precondensates, especially resorcinol-formaldehyde precondensates, and is free of free formaldehyde and formaldehyde-releasing substances,
wherein the crosslinkable rubberization mixture is processible by vulcanization to give a crosslinked rubberization mixture which is at least partly transmissive to visible light at least in sections.

Since the activation of adhesion caused by the aqueous dispersion is a complex coating having a structure that inherently cannot be described precisely, it is necessary to define the textile strength members used in the vulcanizable composite material of the invention via the activation of adhesion that they undergo.

The invention likewise consequently relates to a vulcanized composite material, especially for use as scour guard in vehicle tires, produced or producible by vulcanization of the vulcanizable composite material of the invention, preferably by the process of the invention for producing a vulcanized composite material, comprising a crosslinked rubberization mixture which is at least partly transmissive to visible light, wherein the adhesion-activated textile strength member, at least in sections, is at the surface of the vulcanized composite material, wherein the adhesion-activated textile strength member is preferably partly surrounded by the crosslinked rubberization mixture.

The invention likewise relates to a vehicle tire, especially a bicycle tire, comprising a vulcanized composite material of the invention, preferably produced or producible by the process of the invention for production of a vehicle tire.

Preference is given in this respect to a vehicle tire comprising the vulcanized composite material in the sidewall region, preferably as outermost layer, especially as scour guard.

Preference is additionally given to a vehicle tire additionally comprising, in the region of the vulcanized composite material, one or more rubber labels applied by vulcanization and/or a printed label, preferably one or more rubber labels applied by vulcanization.

Proposed hereinafter is an illustrative configuration of the process of the invention, which, in the view of the inventors, is a particularly advantageous configuration. Moreover, an inventive bicycle tire produced by this illustrative process is proposed, which comprises a vulcanized composite material of the invention as scour guard and which, in the view of the inventors, is likewise a particularly favorable embodiment of a vehicle tire of the invention in which the benefits of the present invention are manifested particularly clearly.

In the context of the illustrative process, a textile strength member is provided, which is a weave composed of multiple reinforcement cords, where the reinforcement cords are respectively an aramid yarn having a linear density of 420 dtex and a nylon yarn having a linear density of 470 dtex, which are end-twisted together at 320 T/m. The aramid yarn used is yellowish in color, whereas the nylon yarn has a manufacturer-specific identification thread marker.

The textile strength member is adhesion-activated with an aqueous dispersion by a dipping method and processed by hot stretching. The aqueous dispersion does not contain free resorcinol or free resorcinol condensates or free formaldehyde or formaldehyde-releasing substances. The aqueous dispersion used is a composition comprising vinylpyridine latex in a proportion by mass based on the dry weight of the aqueous dispersion of 20%, blocked hexamethylene diisocyanate in a proportion by mass based on the dry weight of the aqueous dispersion of 5%, and polyisoprene rubber latex in a proportion by mass based on the dry weight of the aqueous dispersion of 10%. In addition, the aqueous dispersion preferably also comprises an acrylic acid-based polycarboxylic acid and, as epoxy compound, glycerol-based polyglycidyl ether.

Subsequently, the adhesion-activated strength member is disposed on the surface of a base material in the form of a ply that comprises a crosslinkable rubberization mixture. The crosslinkable rubberization mixture comprises 25 phr of a brominated copolymer of isobutylene and para-methylstyrene and 55 phr of natural polyisoprene and 20 phr of cis-1,4-butadiene rubber. The crosslinkable rubberization mixture additionally comprises 30 phr of amorphous silicon dioxide as filler and is free of black colorants, especially black pigments such as carbon black or graphene. As part of a customary vulcanization system, the crosslinkable rubberization mixture additionally comprises 2.4 phr of sulfur, and additionally customary further constituents such as silane coupling agents and tackifying resins, where these are selected such that they do not impair the transparency of the crosslinked rubberization mixture. This crosslinkable rubberization mixture results, after the vulcanization, in a crosslinked rubberization mixture which, in its entirety, is transmissive to visible light having wavelengths in the range from 380 to 780 nm, such that the textile strength members embedded in the transparent crosslinked rubberization mixture are readily apparent from the outside to the naked eye, even in the regions masked by the rubberization.

The vulcanizable composite material produced as described above, as a constituent of the sidewall, is assembled together with other components to give an unvulcanized bicycle tire blank, where the vulcanizable composite material in the side region of the bicycle tire blank is arranged such that the textile strength members are on the outside of the surface.

An aqueous coating material which is applied to the textile strength members at the surface comprises a hard ceramic substance with a proportion by mass of about 7% and a polyisoprene-based binder.

Subsequently, vulcanization of the unvulcanized bicycle tire blank under customary conditions affords a bicycle tire comprising, in the sidewall region, the vulcanized composite material that forms the outermost layer of the bicycle tire, such that the textile strength member lies on the outside of the surface. On vulcanization, the crosslinkable rubberization mixture is pushed against the textile strength member from beneath, such that it is partly surrounded by the crosslinked rubberization mixture in the vulcanized bicycle tire.

1-9. (canceled)

10. A process for producing a vulcanizable composite material, comprising the steps of:
a) producing or providing a textile strength member,
b) treating the textile strength member with an aqueous dispersion for adhesive activation of the textile strength member and to obtain an adhesion-activated textile strength member and
c) arranging the adhesion-activated textile strength member on the surface of a base material comprising a crosslinkable rubberization mixture to obtain the vulcanizable composite material,
wherein the aqueous dispersion is essentially free of free resorcinol and resorcinol precondensates, especially resorcinol-formaldehyde precondensates, and is free of free formaldehyde and formaldehyde-releasing substances,
wherein the crosslinkable rubberization mixture is processible by vulcanization to give a crosslinked rubberization mixture which is at least partly transmissive to visible light at least in sections.

11. The process as claimed in claim 10, wherein the aqueous dispersion comprises:
(x1) at least one rubber latex in a proportion by mass based on the dry weight of the aqueous dispersion of 4% to 60%, and
(x2) at least one protected isocyanate in a proportion by mass based on the dry weight of the aqueous dispersion of 0.1% to 10%.

12. The process as claimed in claim 10, wherein the aqueous dispersion comprises:
(y1) at least one compound containing an epoxy group, and/or
(y2) at least one polymer having carboxylic acid-functional groups.

13. The process as claimed in claim 10, wherein the aqueous dispersion comprises:
(y1) at least one compound containing an epoxy group in a proportion by mass based on the dry weight of the aqueous dispersion of up to 6%, and/or
(y2) at least one polymer having carboxylic acid-functional groups in a proportion by mass based on the dry weight of the aqueous dispersion of up to 15%.

14. The process as claimed in claim 10, wherein the aqueous dispersion comprises one of the following components:
(z1) at least one filler in a proportion by mass based on the dry weight of the aqueous dispersion of 0.02% to 20%, preferably with the proviso that the aqueous dispersion does not include any polymer having carboxylic acid-functional groups, or
(z2) at least one polyisoprene rubber latex in a proportion by mass based on the dry weight of the aqueous dispersion of 1% to 20%, preferably with the proviso that the aqueous dispersion includes at least one rubber latex which is not a polyisoprene rubber latex, or
(z3) at least one wax in a proportion by mass based on the dry weight of the aqueous dispersion of 0.3% to 30%.

15. The process as claimed in claim 10, additionally comprising the step of:
d) producing an unvulcanized vehicle tire blank comprising the vulcanizable composite material.

16. A process for producing a vehicle tire or a vulcanized composite material, comprising the steps of the process as claimed in claim 10, and additionally at least one of the following steps:
e) vulcanizing the vulcanizable composite material to obtain a vulcanized composite material, and/or
f) vulcanizing the unvulcanized vehicle tire blank to obtain a vehicle tire,
wherein the vulcanizing is effected such that the adhesion-activated textile strength member, at least in sections, lies at the surface of the vulcanized composite material and/or of the vehicle tire.

17. The process as claimed in claim 16, wherein the vulcanizing is effected such that the adhesion-activated textile strength member is partly surrounded by the crosslinked rubberization mixture.

18. A vulcanizable composite material for the production of vehicle tires, comprising:
i) at least one textile strength member that has been adhesion-activated at least in sections with an aqueous dispersion, and
ii) a base material comprising a crosslinkable rubberization mixture,
wherein the textile strength member is disposed at the surface of the base material,
wherein the aqueous dispersion is essentially free of free resorcinol and resorcinol precondensates, especially resorcinol-formaldehyde precondensates, and is free of free formaldehyde and formaldehyde-releasing substances,
wherein the crosslinkable rubberization mixture is processible by vulcanization to give a crosslinked rubberization mixture which is at least partly transmissive to visible light at least in sections.

19. The vulcanizable composite material as claimed in claim 18, wherein the at least one textile strength member that has been adhesion-activated essentially entirely with the aqueous dispersion.

20. The vulcanizable composite material as claimed in claim 18, wherein the textile strength member is partly surrounded by the crosslinkable rubberization mixture.

21. A vulcanized composite material, especially for use as scour guard in vehicle tires, produced or producible by vulcanization of the vulcanizable composite material as claimed in claim 18, comprising a crosslinked rubberization mixture which is at least partly transmissive to visible light, wherein the adhesion-activated textile strength member, at least in sections, is at the surface of the vulcanized composite material.

22. The vulcanized composite material as claimed in claim 21, wherein the adhesion-activated textile strength member is partly surrounded by the crosslinked rubberization mixture.

27. A vehicle tire comprising a vulcanized composite material as claimed in claim 21.
